(19) United States
(12) Patent Application Publication
(10) Pub. No.: US 2007/0025201 A1
(43) Pub. Date: Feb. 1, 2007

(54) METHOD FOR DETERMINING A DRIVING FORCE TO DRIVE AN OPTICAL PICKUP HEAD

(75) Inventors: Po Chen Huang, Hsinchu (TW); Chih Chung Chiao, Hsinchu (TW); Yuyu Chen, Hsinchu (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Lite-On It Corp., Taipei City (TW)

(21) Appl. No.: 11/456,423

(22) Filed: Jul. 10, 2006

(30) Foreign Application Priority Data
Jul. 27, 2005 (TW) 094125466

(51) Int. Cl. G11B 21/08

(52) U.S. Cl. 369/30.07

(57) ABSTRACT

A method for determining a driving force to drive an optical pickup head of an optical disc drive includes steps of inserting an optical storage media including absolute address marks into the optical disc drive; sequentially providing a plurality of driving indexes for generating testing driving forces for the optical disc drive to move the optical pickup head from the a first absolute address mark to a second absolute address mark; selecting a first driving force index, which corresponds to a testing driving force incapable of successfully moving the optical pickup head from the first absolute address mark to the second absolute address mark; determining a target driving index by adding an offset value to the first driving index; and generating the driving force according to the target driving index.

### FIELD OF THE INVENTION

The present invention relates to a method of determining a driving force, and more particularly to a method for determining a driving force to drive an optical pickup head of an optical disc drive.

### BACKGROUND OF THE INVENTION

Please refer to FIG. 1. It is a function block diagram of an optical disc drive. The optical disc drive 100 comprises an optical pickup head 10 (PUH) for accessing data recorded on the optical storage media 110, which is rotated by the spindle motor 120. There are two mechanisms to control the radial direction movement of the lens 101 of the optical pickup head 10. The first one is the sled motor 130 to directly drive the sled 102 of the optical pickup head 10 for a long distance move, and the other is the tracking coil 140 to directly drive the lens 101 of the optical pickup head 10 for a short distance move. Besides, the focusing coil 145 is the mechanism to drive the lens 101 of the optical pickup head 10 for a focusing direction movement.

When the optical pickup head 10 accesses the optical storage media 110, weak electric signals are generated. After the radio frequency amplifier 150 processes the weak electric signals, a radio frequency signal (RF), a tracking error signal (TE), and a focusing error signal (FE) are generated. These signals will be sent to the microprocessor 170 for further processing. According to the variations of the tracking error signal and the focusing error signal, the first motor driver 160 will output three driving signals to control the sled motor 130, the tracking coil 140, and the focusing coil 145. The appropriate driving signals can control the lens 101 of the optical pickup head 10 to the correct tracking position by the radial direction movement, and to the correct focusing position by focusing direction movement when the optical disk drive 100 is reading or recording the optical storage media 110. By the control of the microprocessor 170, the second motor driver 165 also outputs a driving signal to control the spindle motor 120. The appropriate driving signal can keep the optical disc rotating at an appropriate rotating speed.

As shown in FIG. 1, the long distance movement is controlled by the driving force of the sled motor 130. The microprocessor 170 controls the first motor driver 160 to output an appropriate driving signal to the sled motor 130 to generate a driving force to move the sled 102 of the optical pickup head 10 for the long distance movement via a transmission mechanism 190. As known in the art, an action called “move sled home” is executed when the power of the optical disc drive is just turned on. The purpose of executing the action is to make sure the exact position of the optical pickup head 10 before the optical disc drive 100 executes the normal operation. That is to say, right after the power being turned on, the optical disc drive 100 has to move the optical pickup head 10 to a predetermined position (usually the inner portion of the disc). During the action, the microprocessor 170 has to control the first motor driver 160 to output a move-sled-home driving signal for the sled motor to generate a corresponding driving force to move the optical pickup head 10 back to the predetermined position.

Generally speaking, the above-mentioned move-sled-home driving signal is recorded in the firmware of the optical disc drive 100. After designing and testing by a manufacturer, a fixed value of the move-sled-home driving signal is stored in the firmware used in a specific model. However, the frictions between the transmission mechanism 190 and the sled 102 in different optical disc drives are different, even though the optical disc drives belong to the same design with the same model name. So a fixed move-sled-home driving signal stored in the firmware may not be suitable for all of the optical disc drives with the same model. Also, the fixed move-sled-home driving signal will cause the following situations. First, if the friction between the sled 102 and the transmission mechanism 190 is too large, the driving force cannot move the optical pickup head 10 to the predetermined position. Second, if the friction between the sled 102 and the transmission mechanism 190 is too small, the driving force will move the optical pickup head 10 to the predetermined position speedily, and make a noise or even a collision between the sled 102 and the spindle motor 130. Also, The value of the move-sled-home driving signal recorded in the firmware is a very important reference value to the optical pickup head 10 for track seeking and track following. Therefore an improper value of the move-sled-home driving signal will seriously affects the read/write performance of the optical disc drive.

### SUMMARY OF THE INVENTION

Thus, it is an object of the present invention to make improvements to the above-mentioned issues. The present invention provides a method of determining a driving force to drive an optical pickup head of an optical disc drive, comprising: inserting an optical storage media including absolute address marks into the optical disc drive; sequentially providing a plurality of driving indexes for generating testing driving forces for the optical disc drive to move the optical pickup head from the a first absolute address mark to a second absolute address mark; selecting a first driving force index, which corresponds to a testing driving force incapable of successfully moving the optical pickup head from the first absolute address mark to the second absolute address mark; determining a target driving index by adding an offset value to the first driving index; and generating the driving force according to the target driving index.

In an embodiment, the absolute address mark is ATIP, ADIP, PPIT, Q-code, ID-code, or position information recorded on the optical storage media.

In an embodiment, the first driving index corresponds to the largest testing driving force incapable of successfully moving the optical pickup head from the first absolute address mark to the second absolute address mark.

In an embodiment, the method further comprises: selecting a second driving index, which corresponds to the smallest one of the testing driving forces capable of successfully moving the optical pickup head from the first absolute address mark to the second absolute address mark and causes a noise or collision; and determining the offset value as the difference between the first driving index and the second driving index multiplied by a default ratio.

The present invention also provides a for determining a target driving index for generating driving forces to drive an optical pickup head of an optical disc drive, comprising: inserting an optical storage media including absolute address marks into the optical disc drive; sequentially providing a plurality of driving indexes for generating testing driving forces to move the optical pickup head from the a first absolute address mark to a second absolute address mark; selecting a first driving index, which corresponds to a testing driving force incapable of successfully moving the optical pickup head from the first absolute address mark to the second absolute address mark; and

determining the target driving index by adding an offset value to the first driving index.

In an embodiment, the target driving index is further stored in a firmware of the optical disc drive.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a function block diagram of a typical optical disc drive;

FIG. 2 is a flow chart of a driving force generating method according to a preferred embodiment of the present invention; and

FIG. 3 is a schematic diagram showing an example for determining a target driving index.

### DETAILED DESCRIPTION OF THE PREFERRED EMBODIMENT

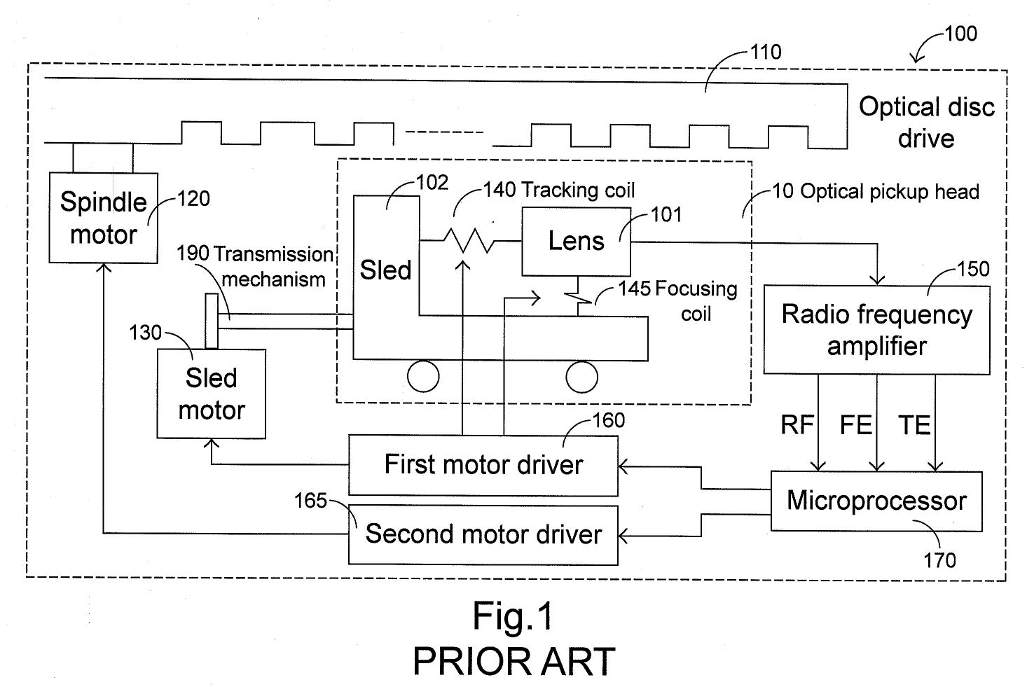

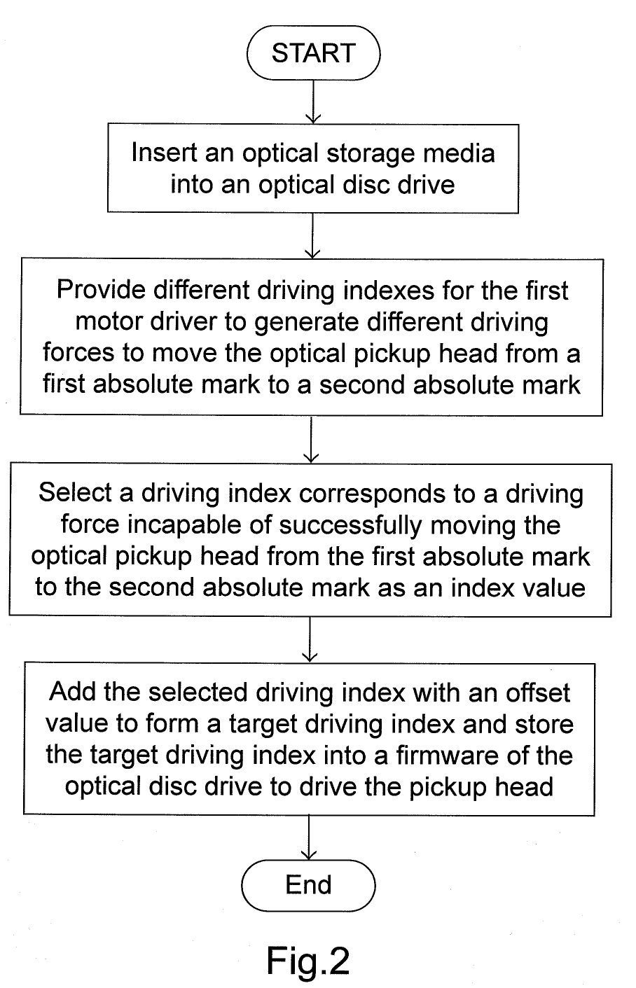

Please refer to FIG. 2. It is a flow chart of the driving force generating method according to a preferred embodiment of the present invention. The method can be use in the hardware architecture shown in the FIG. 1, and the optical disc drive can be a read-only optical disc drive or a recordable optical disc drive. Also, the optical storage media 110 can be a disc compatible with a CD-ROM disc, a CD-R disc, a CD-RW disc, a DVD-ROM disc, a DVD-R disc, a DVD+R disc, a DVD-RW disc, a DVD+RW disc, or a DVD-RAM disc. According to a driving index of driving signal recorded in the firmware, the microprocessor 170 controls the first motor driver 160 to output a corresponding driving signal to the sled motor 130 for generating the corresponding driving force. According to the present invention, when the assembly of an optical disc drive in a production line is complete, the steps shown in the FIG. 2 are executed for every optical disc drive to obtain a target driving index for the first motor driver to generate driving forces. First, one optical storage media including an absolute address mark such as ATIP, ADIP, PPIT, Q-code, ID-code, or position information recorded in the data area is inserted into the optical disc drive. And then, a subroutine of the firmware is executed. The subroutine provides a plurality of different driving indexes for the first motor driver to generate different driving forces to move the optical pickup head. According to the present invention, all driving forces are sequentially used to move the optical pickup head from a first absolute address mark to a second absolute address mark. Base on the results of movement, these driving forces can be classified into two groups. The first group comprises driving forces capable of successfully moving the optical pickup head from the first absolute address mark to the second absolute address mark. The second group comprises driving forces incapable of moving the optical pickup head from the first absolute address mark to the second absolute address mark.

According to a preferred embodiment, one driving index corresponding to the large-most driving force in the second group is selected as a selected driving index. Then, add the selected driving index with an offset value to form a target driving index, and the target driving index is recorded in the firmware as a reference value for the optical disc drive to generate the driving force to move the optical pickup head.

According to the preferred embodiment, the driving indexes are substantially direct or reverse proportion to the generated driving forces. Therefore, the selected driving index can also be the maximum value or the minimum value among the tested driving indexes that are corresponding to the driving forces in the second group.

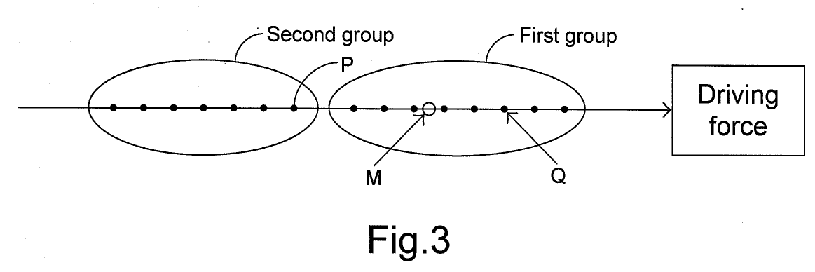

Please refer to FIG. 3. It shows an example for determining a target driving index where the larger driving index is, the lager driving force could be. The optical disc drive can easily distinguish the driving indexes into two groups as mentioned in the previous paragraph. As shown in the FIG. 3, the points on the coordinate axis means a plurality of driving indexes provided by the subroutine of the firmware, and the corresponding driving forces are sequentially higher from the left to the right. By using the indexes within the first group, the generated driving forces can successfully move the optical pickup head from the first absolute address mark to the second absolute address mark. However, the driving forces generated according to the driving indexes in the second group are too small to accomplish this goal. According the prefer embodiment of the present invention, the maximum values P in the second group is selected as the selected driving index. Furthermore, among the first group, the smallest driving index Q whose corresponding driving force can obviously cause a noise or a collision is selected. It can be selected by instruments picking noises during the testing procedure or a predetermined value roughly derived from the prior trials for certain model of design. Then a proper offset value can be determined according to the driving index Q and driving index P. For example, the offset value can be (P−Q) multiplied by a default ratio, such as 0.5.

To find the target driving index M that can induce a proper driving force to move sled smoothly without causing noises and collisions, it could be done by adding the selected driving index P and the offset value 0.5*(P−Q). After doing the finding process, every optical disc drive can store its own target driving index by executing the subroutine of the firmware. Not only the target driving index can be used to perform “move sled home” smoothly and accurately but also is an important reference value for the optical pickup head to stably execute track seeking, track following, and data reading/recording operations. The finding process can not only be executed during the assembly of an optical disc drive as part of the calibration procedure in the factory but also during the customer service to update the target driving index matching the latest wearing and frictional status.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for determining a driving force to drive an optical pickup head of an optical disc drive, comprising:
inserting an optical storage media including absolute address marks into the optical disc drive;
sequentially providing a plurality of driving indexes for generating testing driving forces to move the optical pickup head from the a first absolute address mark to a second absolute address mark;
selecting a first driving index, which corresponds to a testing driving force incapable of successfully moving the optical pickup head from the first absolute address mark to the second absolute address mark;
determining a target driving index by adding an offset value to the first driving index; and
generating the driving force according to the target driving index.

2. The method according to claim 1 wherein the optical disc drive is a read only optical disc drive or a recordable optical disc drive.

3. The method according to claim 1 wherein the optical storage media is compatible with a CD-ROM disc, a CD-R disc, a CD-RW disc, a DVD-ROM disc, a DVD-R disc, a DVD+R disc, a DVD-RW disc, a DVD+RW disc, or a DVD-RAM disc.

4. The method according to claim 1 wherein the absolute address mark is ATIP, ADIP, PPIT, Q-code, ID-code, or position information recorded on the optical storage media.

5. The method according to claim 1 wherein the first driving index corresponds to the largest testing driving force incapable of successfully moving the optical pickup head from the first absolute address mark to the second absolute address mark.

6. The method according to claim 1 further comprises:
selecting a second driving index, which corresponds to the smallest one of the testing driving forces capable of successfully moving the optical pickup head from the first absolute address mark to the second absolute address mark and causes a noise or collision; and
determining the offset value as the difference between the first driving index and the second driving index multiplied by a default ratio.

7. The method according to claim 6 wherein the default ratio is 0.5.

8. The method according to claim 1 wherein the target driving index is stored in a firmware of the optical disc drive.

9. A method for determining a target driving index for generating driving forces to drive an optical pickup head of an optical disc drive, comprising:
inserting an optical storage media including absolute address marks into the optical disc drive;
sequentially providing a plurality of driving indexes for generating testing driving forces to move the optical pickup head from the a first absolute address mark to a second absolute address mark;
selecting a first driving index, which corresponds to a testing driving force incapable of successfully moving the optical pickup head from the first absolute address mark to the second absolute address mark; and
determining the target driving index by adding an offset value to the first driving index.

10. The method according to claim 9 wherein the optical disc drive is a read only optical disc drive or a recordable optical disc drive.

11. The method according to claim 9 wherein the optical storage media is compatible with a CD-ROM disc, a CD-R disc, a CD-RW disc, a DVD-ROM disc, a DVD-R disc, a DVD+R disc, a DVD-RW disc, a DVD+RW disc, or a DVD-RAM disc.

12. The method according to claim 9 wherein the absolute address mark is ATIP, ADIP, PPIT, Q-code, ID-code, or position information recorded on the optical storage media.

13. The method according to claim 9 wherein the first driving index corresponds to the largest testing driving force incapable of successfully moving the optical pickup head from the first absolute address mark to the second absolute address mark.

14. The method according to claim 9 further comprises:
selecting a second driving index, which corresponds to the smallest one of the testing driving forces capable of successfully moving the optical pickup head from the first absolute address mark to the second absolute address mark and causes a noise or collision; and
determining the offset value as the difference between the first driving index and the second driving index multiplied by a default ratio.

15. The method according to claim 14 wherein the default ratio is 0.5.

16. The method according to claim 9 wherein the target driving index is stored in a firmware of the optical disc drive.
